(19) United States
(12) Patent Application Publication
(10) Pub. No.: US 2014/0002253 A1
(43) Pub. Date: Jan. 2, 2014

(54) MOTOR VEHICLE

(71) Applicants: Kerim Yilmaz, Stuttgart (DE); Deniz Yilmaz, Stuttgart (DE)

(72) Inventors: Kerim Yilmaz, Stuttgart (DE); Deniz Yilmaz, Stuttgart (DE)

(21) Appl. No.: 13/996,540

(22) PCT Filed: Dec. 14, 2011
(86) PCT No.: PCT/EP2011/072782

§ 371 Date: Sep. 16, 2013

(30) Foreign Application Priority Data
Dec. 21, 2010 (DE) 10 2010 063 742.4

(51) Int. Cl. G08G 1/16

(52) U.S. Cl. CPC G08G 1/165
USPC 340/435

(57) ABSTRACT

The invention relates to a motor vehicle (1), comprising several vehicle wheels (2), each wheel having a rim (3) and a tire (4). According to the invention, a distance measuring device (5) comprising at least one sensor (6) and an indicating device (8) is arranged in the passenger compartment. The at least one sensor is designed in such a way that the at least one sensor detects a distance between at least one of the rims (3) and an adjacent obstacle, in particular a curb (9), and transmits a corresponding signal to the indicating device (8). Said indicating device (8) is designed in such a way that it produces at least one warning signal when a predefined distance between at least one rim (3) and the adjacent obstacle is reached or fallen below. A sensor (6) of the distance measuring device (5) is arranged on the vehicle wheel (2) and at least one sensor (6) is designed as an RFID chip.

The present invention relates to a motor vehicle having multiple vehicle wheels which have in each case one wheel rim and one tire, as per the preamble of claim 1. The invention also relates to a distance measurement device and to a vehicle wheel for a motor vehicle of said type.

High-grade motor vehicles normally have a multiplicity of assistance systems, in particular also parking aids which, by means of distance sensors, display to a driver the distances to adjacent obstacles or vehicles and thereby facilitate a parking process. Such high-grade vehicles often also have high-grade and thus expensive wheel rims, wherein the known electronic assistance systems normally display only a front or front-side distance and a rear or rear-side distance between the vehicle and the detected obstacles, and in particular do not detect distances to low obstacles, such as for example a curb. With the known assistance systems, it is therefore generally not possible to prevent the vehicle from coming into contact, by way of its wheel rims, with a curb, for example, and the wheel rims thus being damaged.

The present invention is therefore concerned with the problem of specifying, for a motor vehicle of the generic type, an improved or at least alternative embodiment which in particular reduces a risk of damage to wheel rims.

Said problem is solved according to the invention by means of the subjects of the independent claims. The dependent claims relate to advantageous embodiments.

The present invention is based on the general concept, in the case of a motor vehicle known per se and having multiple vehicle wheels which have in each case one wheel rim and one tire, and having an exterior rear-view mirror, of providing a distance measurement device which detects a distance between a vehicle wheel, in particular the wheel rim, and an adjacent obstacle, for example a curb, and which generates a signal when a predefined distance between the vehicle wheel, that is to say in particular the wheel rim, and the adjacent obstacle is reached or undershot, and there is thus the risk of damage to the wheel rim as a result of contact with the curb. Here, the distance measurement device according to the invention has at least one sensor on the vehicle wheel, on the exterior rear-view mirror, on/in the tire and/or on a wheel arch of the motor vehicle, and has a display device in the passenger compartment, wherein the at least one sensor is designed to detect a distance to the adjacent obstacle, in particular to the adjacent curb, and to transmit a corresponding signal to the display device, and wherein the display device in turn is designed to generate a warning signal at least when the predefined distance between the wheel rim and the adjacent obstacle is reached or undershot. Similarly to known parking aids, the distance measurement device according to the invention signals to the driver when the motor vehicle, by way of its wheel rims, comes dangerously close to an adjacent curb and there is thus the risk of the wheel rims being scratched. Such scratches normally cannot be removed again or can be removed again only through expensive and cumbersome methods, such that the distance measurement device according to the invention contributes in particular to protecting expensive wheel rim sets against damage.

In one advantageous refinement of the solution according to the invention, the at least one sensor is arranged in the region of an outer wheel rim flange of the vehicle wheel. In this way, the at least one sensor according to the invention is in an exposed position which is particularly advantageous for evaluating the distance to an adjacent obstacle, in particular to the adjacent curb. In a further advantageous embodiment of the solution according to the invention, the at least one sensor is arranged in the region of a hub or of a wheel bolt and can thus be positioned particularly inconspicuously, whereby an external appearance of a conventional vehicle wheel does not differ, or differs only insignificantly, from that of a vehicle wheel with a distance measurement device according to the invention.

The at least one sensor is expediently in the form of an RFID (radio frequency identification) chip. Such RFID chips permit data transmission by means of electromagnetic waves, and in particular also a supply of energy to the RFID chip by means of such electromagnetic waves, such that signal transmission is possible not only wirelessly but rather also without the need for additional separate energy stores, such as for example a battery, assigned to the sensor to be regularly exchanged. A virtually freely selectable transmission of data is possible by means of such RFID chips, such that these are particularly suitable for the application according to invention. Furthermore, such RFID chips can be produced inexpensively and in compact form, such that the additional costs of the distance measurement device according to the invention are worthwhile even in the case of moderately expensive wheel sets in order to be able to effectively protect these against being undesirably damaged against curbs.

Further important features and advantages of the invention will emerge from the subclaims, from the drawings and from the associated figure description on the basis of the drawings.

It is self-evident that the features mentioned above and the features yet to be explained below can be used not only in the respectively specified combination but rather also in other combinations or individually without departing from the scope of the present invention.

Preferred exemplary embodiments of the invention are illustrated in the drawing and will be explained in more detail in the following description, wherein identical or similar or functionally identical components are denoted by the same reference signs.

In the drawing, in each case schematically:

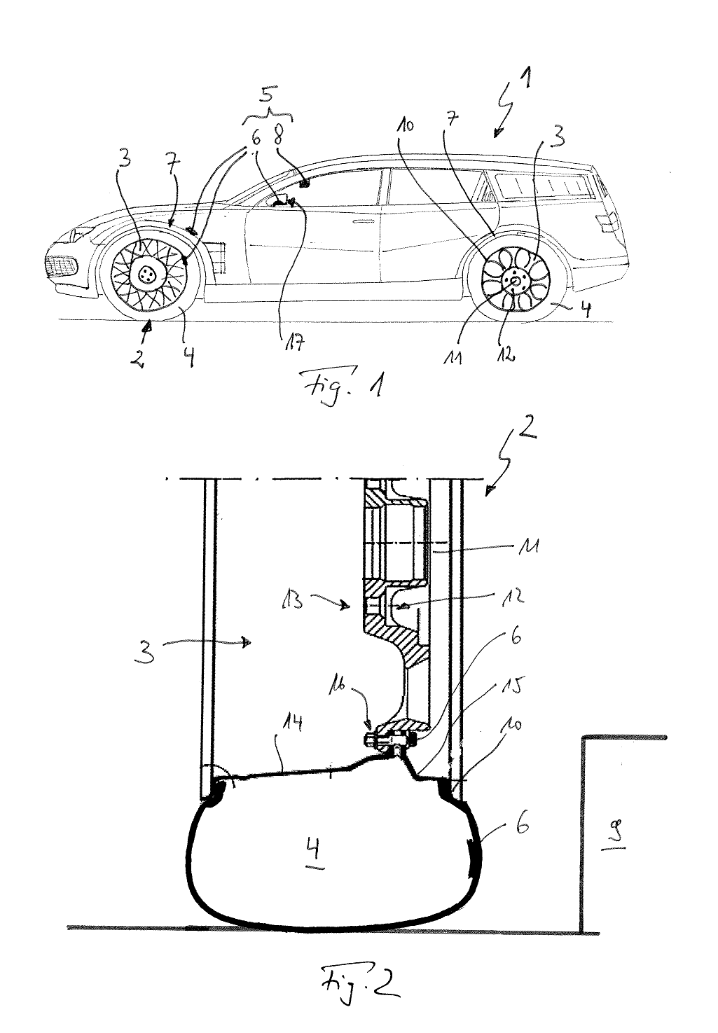

FIG. 1 shows a motor vehicle according to the invention in a side view, and

FIG. 2 shows a sectional illustration through a vehicle wheel of the motor vehicle.

Corresponding to FIG. 1, a motor vehicle 1 according to the invention has, in the conventional manner, an exterior rear-view mirror 17 and multiple vehicle wheels 2, which have in each case one wheel rim 3 and one tire 4 (cf. also FIG. 2). According to the invention, there is now provided a distance measurement device 5 having at least one sensor 6 on the vehicle wheel 2, in/on the tire 4, on the exterior rear-view mirror 17, and/or on a wheel arch 7, and also having a display device 8 in the passenger compartment, wherein the at least one sensor 6 is designed to detect a distance to an adjacent obstacle, in particular to an adjacent curb 9, and to transmit a corresponding signal to the display device 8, wherein said display device is designed to generate a warning signal at least when a predefined distance between the wheel rim 3 and the adjacent obstacle, that is to say the adjacent curb 9, is reached or undershot (cf. FIG. 2).

According to the invention, the at least one sensor 6 may be arranged in the region of an outer wheel rim flange 10 (cf. FIG. 2) of the vehicle wheel 2, and in particular, it is also possible for the at least one sensor 6 to be clamped, and thereby fixed, between the wheel rim flange 10 and the tire 4 of the vehicle wheel 2. As an alternative to this, it is also possible for a sensor ring having multiple sensors 6 to be provided, which sensor ring may in particular likewise be arranged on the outer wheel rim flange 10 of the vehicle wheel 2. It is self-evidently also conceivable for at least one of the sensors 6 to be arranged in the region of a hub 11 or of a wheel bolt 12, and to thereby be positioned in a particularly inconspicuous manner. An arrangement of the sensor 6 in the region of the exterior rear-view mirror 17 is also conceivable.

In general, the wheel rim 3 may also be formed in multiple parts, specifically from a wheel rim star 13 and from an inner and an outer wheel rim well 14, 15, wherein the inner and the outer wheel rim well 14, 15 are screwed to the wheel rim star 13, and wherein the at least one sensor 6 is arranged in the region of said screw connection 16. An arrangement of the at least one sensor in/on the tire 4 is also possible, wherein in this case, the sensor 6 may be vulcanized into the tire 4.

The at least one sensor 6 may for example be in the form of an RFID chip, and can thus communicate, or exchange signals, with the display device 8 in the passenger compartment of the motor vehicle 1 wirelessly. If a predefined distance to the adjacent obstacle or to the adjacent curb 9 is undershot or reached, the display device 8 may generate a haptic, acoustic and/or visual warning signal. If the at least one sensor 6 is arranged not in the vehicle wheel 2 but rather in the region of the wheel arch 7, signal transmission to the display device 8 via wires is also conceivable.

With the distance measurement device 5 according to the invention, it is possible in particular for high-grade wheel rims 3 to be protected in an effective manner against being scratched against a curb 9, wherein additional monetary expenditure is low in relation to a relatively expensive tire or wheel rim set. Here, in FIG. 1, different vehicle wheels 2 have deliberately been shown on the motor vehicle 1 so as to make it clear that the distance measurement device 5 according to the invention is not restricted only to special vehicle wheels 2 or to an arrangement on a front axle or rear axle, but rather may be used in any desired manner.

1. A motor vehicle having multiple vehicle wheels which have in each case one wheel rim and one tire, and having at least one exterior rear-view mirror,
characterized in that
a distance measurement device is provided, having at least one sensor and having a display device arranged in the passenger compartment, wherein the at least one sensor is designed so as to detect a distance between at least one of the wheel rims and an adjacent obstacle, in particular a curb, and to transmit a corresponding signal to the display device, and wherein the display device is designed to generate a warning signal at least when a predefined distance between at least one wheel rim and the adjacent obstacle is reached or undershot,
a sensor of the distance measurement device is arranged on the vehicle wheel,
at least one sensor is in the form of an RFID chip.

2.-9. (canceled)
